(19) United States
(12) Patent Application Publication
(10) Pub. No.: US 2014/0121804 A1
(43) Pub. Date: May 1, 2014

(54) CALIBRATION SYSTEM AND METHOD FOR AUTOMATIC HANDLING EQUIPMENT

(71) Applicant: SHENZHEN CHINA STAR OPTOELECTRONICS TECHNOLOGY CO. LTD., Shenzhen (CN)

(72) Inventors: Zhenhua Guo, Shenzhen (CN); Chunhao Wu, Shenzhen (CN); Kunhsien Lin, Shenzhen (CN); Weibing Yang, Shenzhen (CN); Minghu Qi, Shenzhen (CN); Yunshao Jiang, Shenzhen (CN)

(73) Assignee: SHENZHEN CHINA STAR OPTOELECTRONICS TECHNOLOGY CO. LTD., Shenzhen (CN)

(21) Appl. No.: 13/704,244

(22) PCT Filed: Oct. 30, 2012
(86) PCT No.: PCT/CN12/83728

§ 371 Date: Dec. 14, 2012

(30) Foreign Application Priority Data
Oct. 29, 2012 (CN) 201210420695.X

(51) Int. Cl. G05B 13/02

(52) U.S. Cl. CPC G05B 13/02
USPC 700/108

(57) ABSTRACT

A calibration system for the automatic handling equipment includes automatic handling equipment, transmission modules installed on the automatic handling equipment that generates light rays, a reception module that receives the light rays generated b the transmission module, and a calibration module coupled with the transmission modules and the reception module. The calibration module is used to calibrate the automatic handling equipment via computation of deviations between coordinates of the light rays that the light rays projects on the reception module and preset coordinates.

### TECHNICAL FIELD

The present disclosure relates to the field of manufacturing liquid crystal display (LCD) devices, and more particularly to a calibration system and method for automatic handling equipment.

### BACKGROUND

In order to save labor cost and increase production efficiency, a large number of automatic handling equipment are used in typical liquid crystal display (LCD) panel factories to handle glass substrates. Parts of the automatic handling equipment may deviate from set standards in a long-term working process, in particular, for a fork of the automatic handling equipment, if the deviation is too large, failure of handling the glass substrate is easy to occur, and the glass substrate may even be damaged. Thus, the automatic. handling equipment needs to be calibrated regularly.

For typical automatic handling equipment, such as robots and automatic warehousing systems (STK), when calibrated, the fork is adjusted to a specific position to measure an actual position of the fork by a manual method. Deviation of the fork is computed via the actual position compared with a theoretical position and then manual calibration is conducted as required. Thus, not only a large amount of human resources and material resources are wasted, but also manual measurement deviations may exist.

### SUMMARY

In view of the above-described problems, the aim of the present disclosure is to provide a calibration system and a calibration method for an automatic handling equipment capable of reducing human resources and measurement errors.

The aim of the present disclosure is achieved by the following technical scheme.

A calibration system for an automatic handling equipment comprises an automatic handling equipment. The calibration system further comprises transmission modules installed on the automatic handling equipment projecting light rays, a reception module that receives the light rays projected by the transmission modules, and a calibration module coupled with the transmission modules and the reception module. The calibration module calibrates deviations of the automatic handling equipment via computation of the deviation between coordinates of the projected light rays received by the reception module and preset coordinates.

Furthermore, the number of the transmission modules are at least two. Thus, multiple transmitted light rays are projected, generating multiple coordinate values, which causes measurement accuracy is high. Effect of the calibration can be improved.

Furthermore, the transmission modules are infrared transmission modules. The reception module comprises an infrared reception board with a coordinate recognition function. Infrared rays are not within the range of visible light, thus preventing the light rays from disturbing workers in a working area.

Furthermore, the transmission modules are laser transmission modules. Correspondingly, the reception module comprises a laser reception board with a coordinate recognition function. Light condensation effect of laser is excellent. Thus, the laser beams projected to a reception device are small. The obtained coordinate values of the projected light rays are more accurate, which improves the measurement accuracy.

Furthermore, the reception module comprises a storage unit stored with the preset coordinates and the coordinates of the projected light rays. The reception module sends the preset coordinates and the coordinates of the projected light rays to the calibration module. In the technical scheme, all the coordinates are stored in the reception module. The calibration module directly reads, compares and computes the coordinate positions. Operation efficiency is high, which improves the calibration speed.

Furthermore, the calibration module comprises a storage unit stored with preset coordinates. The reception module sends the coordinates of the projected light rays to the calibration module. In the technical scheme, the reception module is only responsible to collect the coordinates of the projected light rays, and then directly transmitting the coordinates of the projected light rays to the calibration module, which increases the collection and transmission speed of data.

Furthermore, the automatic handling equipment comprises a fork. The transmission modules are fixed to the fork. This is a specified fixed structure of the transmission modules. An aim of calibration is to adjust coordinates of the fork. Thus, the transmission modules are fixed to the fork. The relative coordinates of the transmission modules and the fork keep constant. Change of the fork can be directly reflected from change of the coordinates of the transmission modules, thus simplifying the calibration process.

A calibration method for an automatic handling equipment comprises the following steps:

A: transmitting light rays from a calibrated automatic handling equipment, recording coordinates of the light rays as preset coordinates;

B: transmitting light rays from an calibrated automatic handling equipment to be detected, recording coordinates of the light rays as coordinates to be detected;

C: comparing the calibrated coordinates with the preset coordinates; if the calibrated coordinates deviate from the preset coordinates within preset values, ending the calibration method, if the calibrated coordinates deviate from the preset coordinates beyond the preset values, calibrating the automatic handling equipment and returning to the step B.

Furthermore, the automatic handling equipment transmits at least two light rays. In the step A, at least two preset coordinate values are set. In the step B, the calibrated, coordinate values are in one-to-one correspondence with the preset coordinate values. Thus, multiple transmitted light rays are generated, generating multiple coordinate values. The coordinate values are more causing the measurement accuracy is high. Effect of the calibration can be improved.

Furthermore, in the step A and the step B, the light rays transmitted by the automatic handling equipment are infrared rays or laser beams. As the adopted infrared rays are not within the range of visible light, the light rays can be prevented from disturbing workers in the working area. If the laser beams is adopted, as the light condensation effect of the laser is excellent, laser beams projected to a reception device are small. The obtained coordinate values of the projected light rays are more accurate, which improves measurement accuracy.

In the present disclosure, as the transmission modules transmitting the light rays and the reception module receiving the light rays, optical alignment is conducted in an optical mode. Then, the calibration module is used to automatically determine whether the deviation of the automatic handling equipment exceeds the preset value. If the deviation of the automatic handling equipment exceeds the preset value, the calibration position of the automatic handling equipment is controlled. Manual intervention is not required at all in the process, which reduces the human resources and saves costs. The light rays are directly transmitted and are not easy to be disturbed, thus, the optical alignment is conducted in the optical mode. In comparing the optical mode with a manual measurement mode, the optical mode has a higher accuracy, does not have human errors, and reduces the measurement deviation. Moreover, if the manual calibration node is adopted, the equipment is stopped, thus affecting normal production activities. Because the present disclosure achieves complete automation, operation of the automatic handling equipment is safe. The calibration can be conducted without needing the equipment to be stopped, which saves work time and increase the production efficiency.

### BRIEF DESCRIPTION OF FIGURES

FIG. 1 is a functional block diagram of the present disclosure; and

FIG. 2 is a schematic diagram of an example of the present disclosure.

Legends: 10. automatic handling equipment; 11. fork; 12. transmission module; 13. infrared reception board.

### DETAILED DESCRIPTION

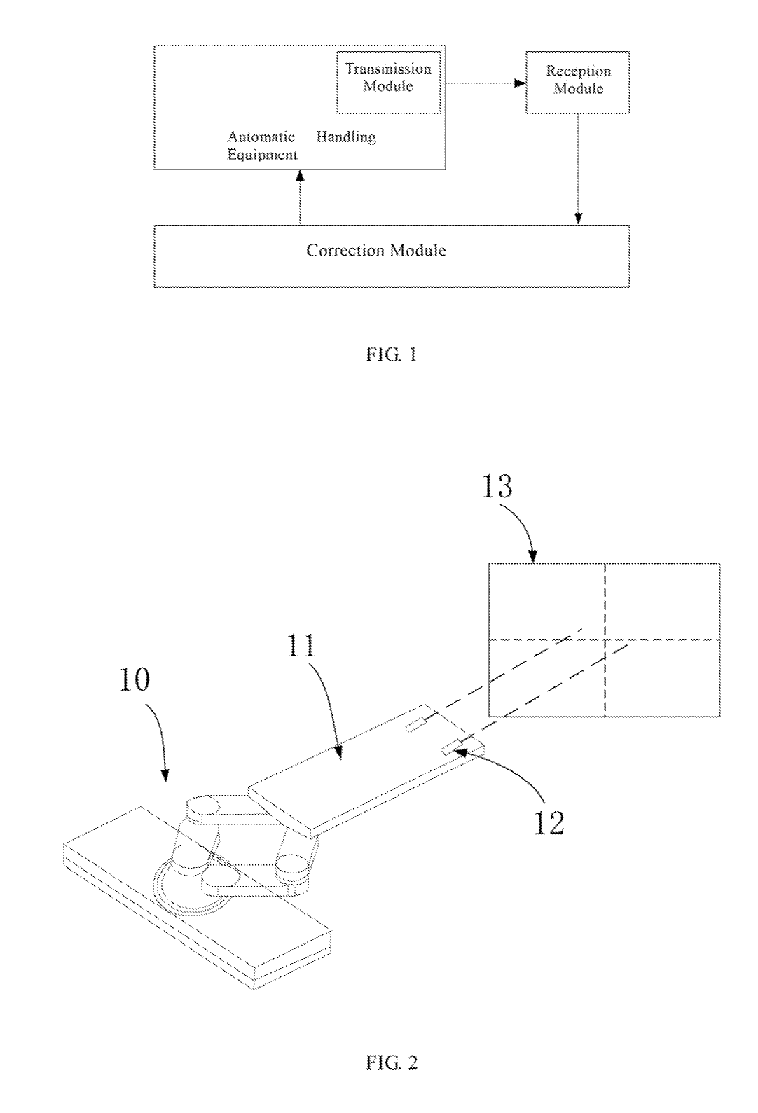

As shown in FIG. 1, the present disclosure discloses a calibration system for an automatic handling equipment. The calibration system comprises an automatic handling equipment, transmission modules installed on the automatic handling equipment that generate light rays, a reception module that receives the light rays generated by the transmission modules, and a calibration module coupled with the transmission modules and the reception module. The calibration module is used to calibrate deviations of the automatic handling equipment via a computation of a deviation between coordinates of the light rays that the light rays projects on the reception module and preset coordinates.

In the present disclosure, as the transmission modules transmitting the light rays and the reception module receiving the light rays, optical alignment is conducted in an optical mode. Then, the calibration module is used to automatically determine whether the deviation of the automatic handling equipment exceeds the preset value. If the deviation of the automatic handling equipment exceeds the preset value, a calibration position of the automatic handling equipment is controlled and manual intervention is not required at all in the process, which reduces human resources and saves costs. The light rays are directly transmitted and are not easy to be disturbed, thus, the optical alignment is conducted in the optical mode. In comparing the optical mode with a manual measurement mode, the optical mode has is higher accuracy, does not have human errors, and reduces measurement deviation. Moreover, if the manual measurement mode is adopted, the equipment needs to be stopped during the manual measurement mode, thus, affecting, normal production. Because the present disclosure achieves complete automation, operation of the automatic handling equipment is safe, and the calibration can be conducted without needing the automatic handling equipment to be stopped, which saves work time and increases production efficiency, if the present disclosure is adopted. The present disclosure is described in detail in accordance with figures and preferable examples as below.

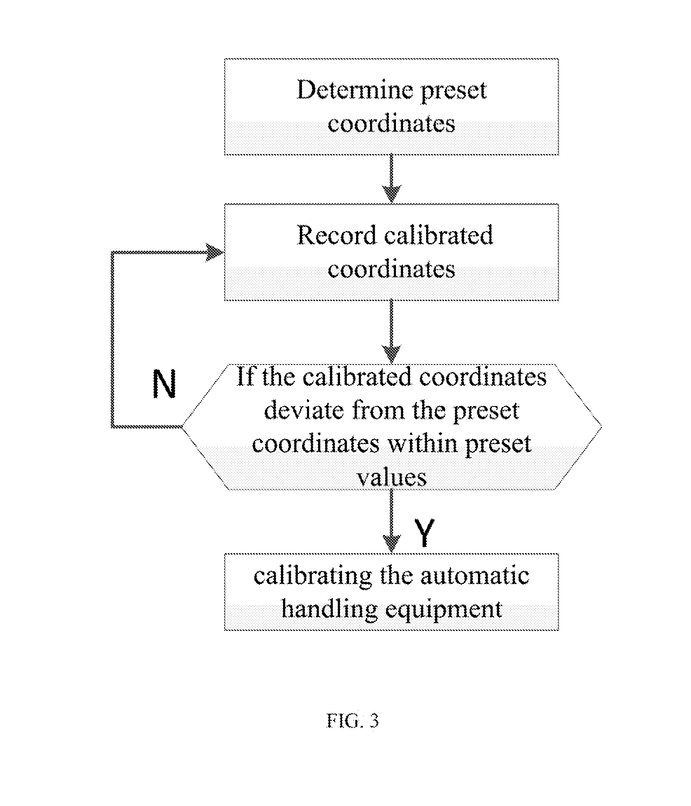

As shown in FIG. 2, the automatic handling equipment 10 of the example is configured with a fork 11. Two infrared transmission modules 12 are fixed on the fork 11. A reception module with an infrared reception board 13 is fixed on a working factory of the automatic handling equipment. The infrared reception board 13 has to coordinate recognition function, which can collect coordinates of the light rays projected by the transmission modules 12, and store the coordinates in a storage unit of the reception module. The storage unit is stored with the preset coordinates (i.e., coordinates corresponding to an initial position of the fork 11). The reception module is used to send the preset coordinates and the coordinates of the light rays to the calibration module. The calibration module is used to calibrate deviations of the fork 11 of the automatic handling equipment 10 via computation of the deviation between the coordinates of the light rays and the preset coordinates. In the example, all the coordinates are stored in the reception module. The calibration module directly reads, compares, and computes the coordinates. The operation efficiency is high, which improves calibration speed.

Alternatively, the calibration module is configured with a storage unit, and the reception module may not be configured with a storage unit. The storage unit of the calibration module is stored with preset coordinates. After the infrared reception board of the reception module collects the coordinate of the light rays projected by the transmission modules, the infrared reception board of the reception module directly sends the coordinates to the storage unit of the calibration module. Then, the calibration module reads data from the storage unit, and calibrates deviations of the fork of the automatic handling equipment via the computation of the deviation between the coordinates of the light rays and the preset coordinates. The reception module is only responsible to collect the coordinates of the light rays, and then directly transmitting the coordinates of the light rays to the calibration module, which increases collection and transmission speed of the data.

The transmission modules can be installed on the fork, or in other positions on the automation handling equipment. An aim of calibration is to adjust coordinates of the fork. Thus, the transmission modules are fixed to the fork. The relative coordinates of the transmission modules and the fork keep constant. Change of the fork can be directly reflected from change of the coordinates of the transmission modules, thus simplifying the calibration process.

One or more transmission modules can be arranged. The number of the transmission modules is smaller thus lowering costs and allowing for simpler computation. If more of the transmission modules are added, the number of the transmitted light rays is increased, thus generating multiple coordinate values. The coordinate values are more causing, higher measurement accuracy. Effect of the calibration can be improved.

The transmission modules can transmit infrared rays. The infrared, rays are not within the range of visible light, thus preventing the light rays from disturbing workers in a working area. The transmission modules can also transmit laser beams. At this moment, the corresponding reception module comprises a laser reception board with a coordinate recognition function. Light condensation effect of the laser is excellent. Thus, the laser beams projected to a reception device are small. The obtained, coordinate values of the light rays are more accurate, which improves the measurement accuracy. The transmission modules can also transmit other light rays for measurement and positioning.

The present disclosure also discloses a calibration method for an automatic handling equipment, comprising the following steps:

A: transmitting light rays from a calibrated automatic handling equipment; recording coordinates of the light rays as preset coordinates;

B: transmitting light rays from an uncalibrated automatic handling equipment, recording coordinates of the light rays as calibrated coordinates;

C: comparing the calibrated coordinates with the preset coordinates; if the calibrated coordinates deviate from the preset coordinates within preset values, ending the calibration method, if the calibrated coordinates deviate from the preset coordinates beyond the preset values, calibrating the automatic handling equipment and returning to the step B.

The automatic handling equipment can transmit more than two light rays in the step A, two preset coordinate values are at least set. In the step B, the calibrated coordinates values are in one-to-one correspondence with the preset coordinate values. Thus, there are multiple transmitted light rays, generating multiple coordinate values. The coordinate values are more causing higher the measurement accuracy. Effect of the calibration can be improved.

In the step A and the step B, the light rays transmitted by the automatic handling equipment are infrared rays, laser beams or other light rays for measurement and positioning. As the adopted infrared rays are not within the range of visible light, the light rays can be prevented from disturbing workers in the working area. If the laser beams is adopted, as the light condensation effect of the laser beams is excellent, the laser beams projected to a reception device are small. The obtained coordinate values of the light rays are more accurate, which improves the measurement accuracy.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A calibration system for an automatic handling equipment, comprising:
at least two transmission modules installed on the automatic handling equipment, the transmission modules projecting light rays;
a reception module that receives the light rays projected by the transmission modules; and
a calibration module coupled with the transmission modules and the reception module;
wherein the calibration module calibrates deviations of the automatic handling equipment via computation of a deviation between coordinates of the projected light rays received by the reception module and preset coordinates;
wherein the automatic handling equipment comprises a fork; the transmission modules are fixed to the fork; the transmission modules are infrared transmission modules; the reception module comprises an infrared reception board with a coordinate recognition function; the reception module comprises a storage unit stored with the preset coordinates and the coordinates of the projected light rays; the reception module sends the preset coordinates and the coordinates of the projected light ray to the calibration module.

2. A calibration system for an automatic handling equipment, comprising:
transmission modules installed on the automatic handling equipment, the transmission modules projecting light rays;
a reception module that receives the light rays projected by the transmission modules; and
a calibration module coupled with the transmission modules and the reception module;
wherein the calibration module calibrates the automatic handling equipment via computation of deviations between coordinates of the projected light ray received by the reception module and preset coordinates.

3. The calibration system for the automatic handling equipment of claim 2, wherein the reception module comprises a storage unit stored with the preset coordinates and the coordinates of the projected light rays; the reception module sends the pies coordinates and the coordinates of the projected light rays to the calibration nodule.

4. The calibration system for the automatic handling equipment of claim 2, wherein the number of the transmission modules are at least two.

5. The calibration system for the automatic handling equipment of claim 4, wherein the reception module comprises a storage unit stored with the preset coordinates and the coordinates of the projected light rays^{.}, the reception module sends the preset coordinates and the coordinates of the projected light rays to the calibration module.

6. The calibration system for the automatic handling equipment of claim 2, wherein the transmission modules are infrared transmission modules; the reception module comprises an infrared reception board with a coordinate recognition function.

7. The calibration system for the automatic handling equipment of claim 6, wherein the reception module comprises a storage unit stored with the preset coordinates and the coordinates of the projected light rays; the reception module sends the preset coordinates and the coordinates of the projected light rays to the calibration module.

8. The calibration system for the automatic handling equipment of claim 2, wherein the transmission modules are laser transmission modules; the reception module comprises a laser reception board with a coordinate recognition function.

9. The calibration system for the automatic handling equipment of claim 2, wherein the calibration module comprises a storage unit stored with preset coordinates; the reception module sends the coordinates of the projected light rays to the calibration module.

10. The calibration system for the automatic handling equipment of claim 2, wherein the automatic handling equipment comprises a fork; the transmission modules are fixed to the fork.

11. A calibration method for an automatic handling equipment, comprising the following steps:
A: transmitting light rays from a calibrated automatic handling equipment; recording coordinates of the light rays as preset coordinates;
B: transmitting light rays from an uncalibrated automatic handling equipment; recording coordinates of the light rays as calibrated coordinates;
C: comparing the calibrated coordinates with the preset coordinates; if the calibrated coordinates deviate from the preset coordinates within preset values, ending the calibration method; if the calibrated coordinates deviate from the preset coordinates beyond the preset values, calibrating the automatic handling equipment and returning to the step B.

12. The calibration method for the automatic handling equipment of claim 11, wherein the automatic handling equipment transmits at least two light rays; in the step A, at least two preset coordinate values are set; in the step B, the calibrated coordinate values are in one-to-one correspondence with the preset coordinate values.

13. The calibration method for the automatic handling equipment If claim 11, wherein in the step A and the step B, the light rays transmitted by the automatic handling equipment are infrared rays or laser beams.
